(19) United States
(12) Patent Application Publication
(10) Pub. No.: US 2010/0317396 A1
(43) Pub. Date: Dec. 16, 2010

(54) COMMUNICATION SYSTEM

(76) Inventors: Michael Reymond Reynolds, Cambridge (GB); Peter John Kelly, Cambridge (GB); John Rye, Cambridge (GB); Ian Michael Hosking, Cambridge (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/601,878

(22) PCT Filed: May 29, 2008
(86) PCT No.: PCT/GB2008/001820

§ 371 Date: Apr. 28, 2010

(30) Foreign Application Priority Data
May 29, 2007 (GB) 0710211.4

(51) Int. Cl. G06F 17/00; H04M 1/00

(52) U.S. Cl. 455/550.1; 700/94

(57) ABSTRACT

A cellular telephone is provided for recovering hidden data that is embedded within an input acoustic signal. The telephone passes the acoustic signal through an audio coder of the telephone and then processes the compressed audio generated by the audio coder, to recover the hidden data. A similar telephone is also provided for identifying the audio signal from the compressed output of the audio coder. Various coding techniques are also described for hiding the data within the audio.

This invention relates to a communication system. The invention has particular, but not exclusive relevance to communications systems in which a telephone apparatus such as a cellular telephone is provided with data via an acoustic data channel.

WO02/45273 describes a cellular telephone system in which hidden data can be transmitted to a cellular telephone within the audio of a television or radio programme. In the present context, the data is hidden in the sense that it is encoded in order to try to hide the data in the audio so that is not obtrusive to the user and is masked to a certain extent by the audio.

As those skilled in the art will appreciate, the acceptable level of audibility of the data will vary depending on the application and the user involved. Various techniques are described in this earlier application for encoding the data within the audio, including spread spectrum encoding, echo modulation, critical band encoding etc. However, the inventors have found that the application software has to perform significant processing in order to be able to recover the hidden data.

One aim of one embodiment, therefore, is to reduce the processing requirement of the software application.

In one embodiment, a method is provided for recovering hidden data from an input audio signal or for identifying an input audio signal using a telecommunications device having an audio coder for compressing the input audio signal for transmission to a telecommunications network, the method being characterised by passing the input audio signal through the audio codec to generate compressed audio data and processing the compressed audio data to recover the hidden data or to identify the input audio signal. The inventors have found that by passing the input audio through the audio coder, the amount of subsequent processing required to recover the hidden data or to identify the input audio can be significantly reduced. In particular, this processing can be performed without having to regenerate the audio samples and then start with the conventional techniques for recovering the hidden data or for identifying the audio signal.

In one embodiment, the audio coder performs a linear prediction, LP, analysis on the input audio to generate LP data representative of the input audio and wherein the processing step processes the LP data to recover the hidden data or to identify the input audio signal. Preferably, the audio coder compresses the LP data to generate the compressed LP data and the processing step includes the step of regenerating the LP data from the compressed audio data.

The LP data generated by the coder may include LP filter data, such as LPC filter coefficients, filter poles or line spectral frequencies and the processing step recovers the hidden data or identifies the audio signal using this LP filter data.

The processing step may include the step of generating an impulse response of the LP synthesis filter or the step of performing a reverse Levinson-Durbin algorithm on the LP filter data. When generating the impulse response, its autocorrelation is preferably taken from which the presence or absence of the echoes can be identified more easily than from the impulse response itself.

The LP data generated by the audio coder may include LP excitation data (such as codebook indices, excitation pulse positions, pulse signs etc) and the processing step may recover the hidden data or may identify the audio signal using this LP excitation data.

In most cases, the LP data will include both LP filter data and LP excitation data and the processing step may processes all or a subset of the compressed audio data corresponding to one of said LP filter data and said LP excitation data to recover the hidden data.

The data can be hidden within the audio signal using a number of techniques. However, in a preferred embodiment, the data is hidden in the audio as one or more echoes of the audio signal. The hidden data can then be recovered by detecting the echoes. Each symbol of the data to be hidden may be represented by a combination of echoes (at the same time) or as a sequence of echoes within the audio signal and the processing step may include the step of identifying the combinations of echoes to recover the hidden data or the step of tracking the sequence of echoes in the audio to recover the hidden data.

In one embodiment, the audio coder has a predefined operating frequency band and the echoes are hidden within the audio within a predetermined portion of the operating band, preferably an upper portion of the frequency band, and wherein the processing step includes a filtering step to filter out frequencies outside this predetermined portion. For example, where the audio coder has an operating band of 300 Hz to 3.4 kHz, the echo may be included only in the band between 1 kHz and 3.4 kHz and more preferably between 2 kHz and 3.4 kHz, as this can reduce the effects of the audio signals whose energy typically is located within the lower part of the operating bandwidth. In another embodiment, the echo is included throughout the operating bandwidth but the processing step still performs the filtering, to reduce the effects of the audio. This is not as preferred as part of the echo signal will be lost in the filtering as well.

In order to help identify the presence of echoes in the audio coder output, the processing step may determine one or more autocorrelation values, which help to highlight the echoes.

Inter frame filtering of the autocorrelation values may also be performed to reduce the effects of slowly varying audio components.

The audio coder used may be any of a number of known coder such as a CELP coder, AMR coder, wideband AMR coder etc.

In one embodiment, the processing step may determine a spectrograph from the compressed audio data output from the coder and then identify characteristic features (similar to a fingerprint) in the spectrograph. These characteristic features identify the audio input and can be used to determine track information for the audio for output to the user or which can be used to synchronise the telecommunications device to the audio signal, for example outputting subtitles relating to the audio.

Another embodiment provides a telecommunications device comprising: means for receiving acoustic signals and for converting the received acoustic signals into corresponding electrical audio signals; means for sampling the electrical audio signals to produce digital audio samples; audio coding means for compressing the digital audio samples to generate compressed audio data for transmission to a telecommunications network; and data processing means, coupled to said audio coding means, for processing the compressed audio data to recover hidden data conveyed within the received acoustic signal or to identify the received acoustic signal.

One embodiment of the invention also provides a data hiding apparatus comprising: audio coding means for receiving and compressing digital audio samples representative of an audio signal to generate compressed audio data; means for receiving data to be hidden within the audio signal and for varying the compressed audio data in dependence upon the received data, to generate modified compressed audio data; and means for generating audio samples using the modified compressed audio data, the audio samples representing the original audio signal and conveying the hidden data.

Another embodiment provides a method of hiding data in an audio signal, the method comprising the steps of adding one or more echoes to the audio in dependence upon the data to be hidden in the audio signal and is characterised by high pass filtering the echo before combining it with the audio signal. The inventors have found that by adding the echo only in a higher frequency band of the audio signal, the echoes can be detected more easily and reduces wasted energy in applying the echo throughout the audio band.

These and other aspects of the invention will become apparent from the following detailed description of exemplary embodiments which are described with reference to the accompanying drawings, in which:

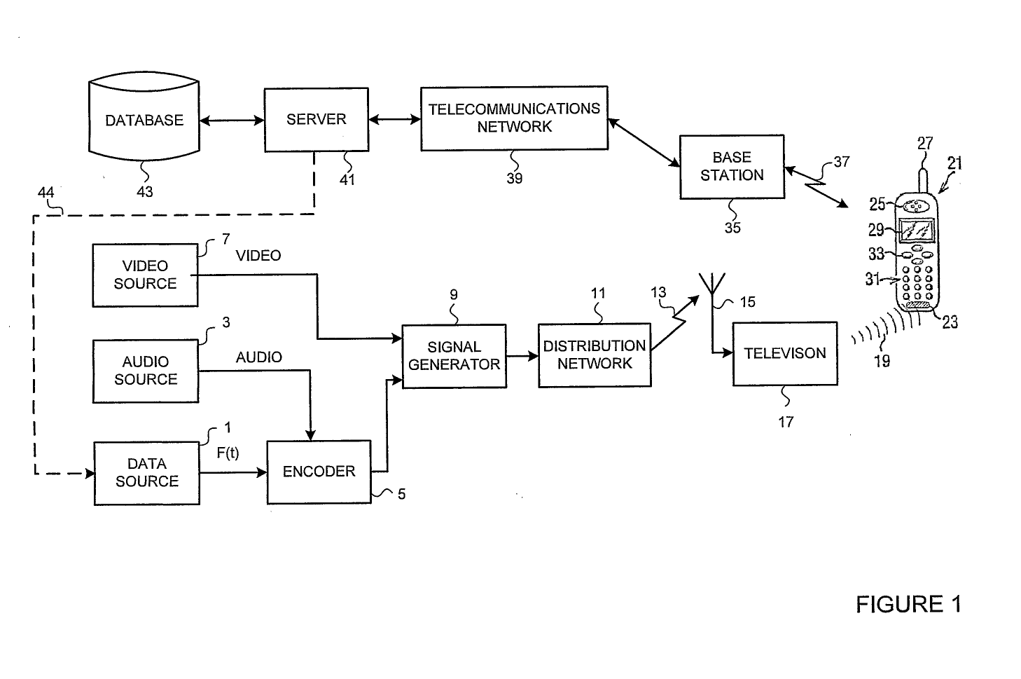

FIG. 1 schematically shows a signalling system for communicating data to a cellular telephone via the audio portion of a television signal;

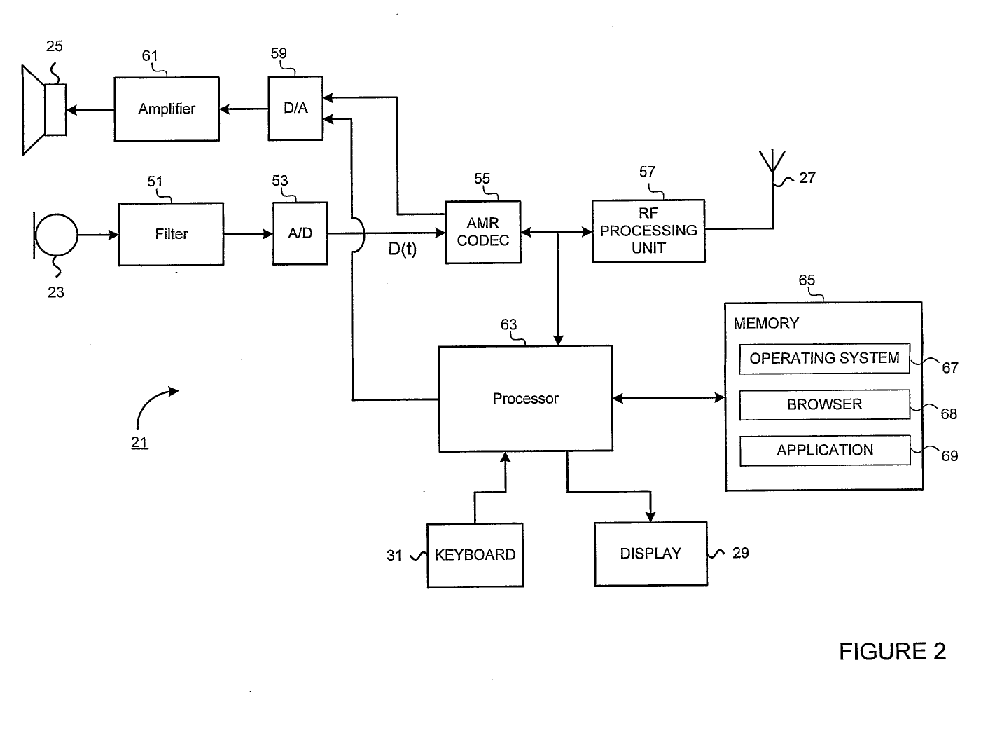

FIG. 2 is a schematic block diagram illustrating the main components of a cellular telephone including software applications for recovering data hidden within a received audio signal;

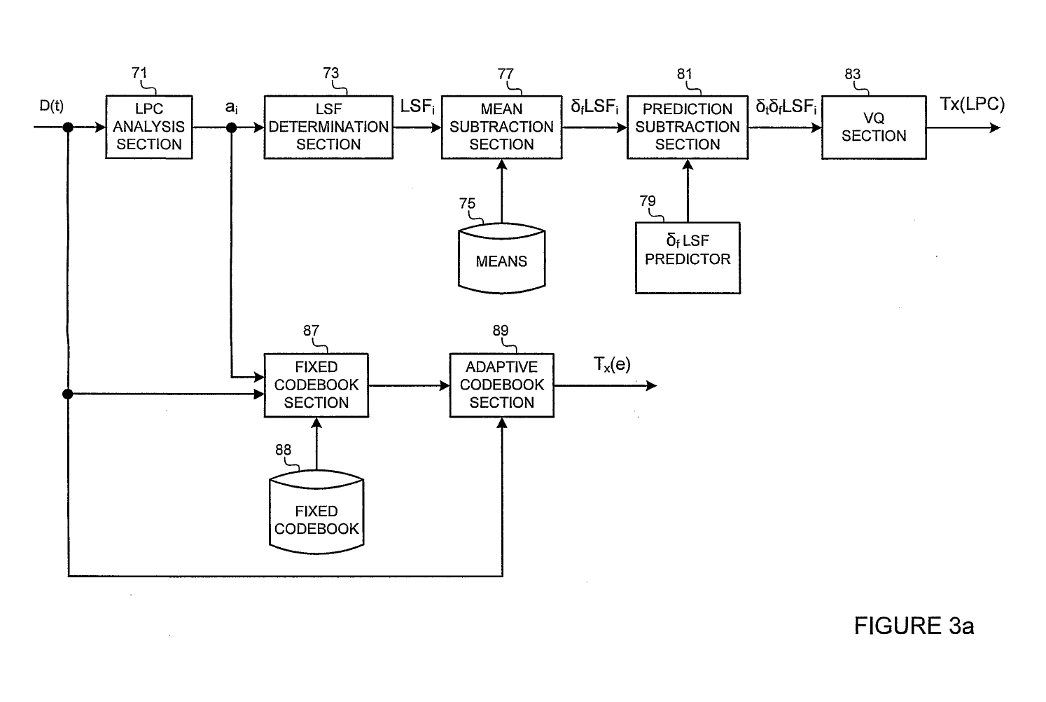

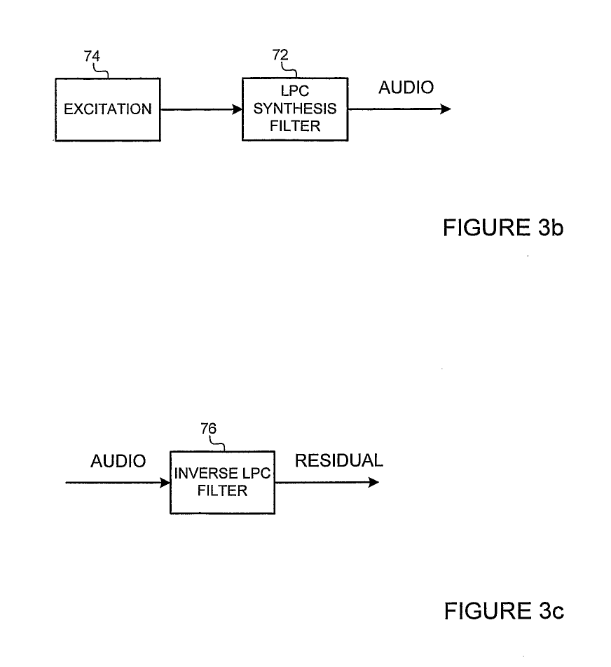

FIG. 3a is a block schematic diagram illustrating the processing performed by an audio codec forming part of the cellular telephone illustrated in FIG. 2;

FIG. 3b illustrates a source-filter model underlying LP coding of audio signals;

FIG. 3c illustrates the way in which an inverse LPC filter can be used to generate an excitation or residual signal from an input audio signal;

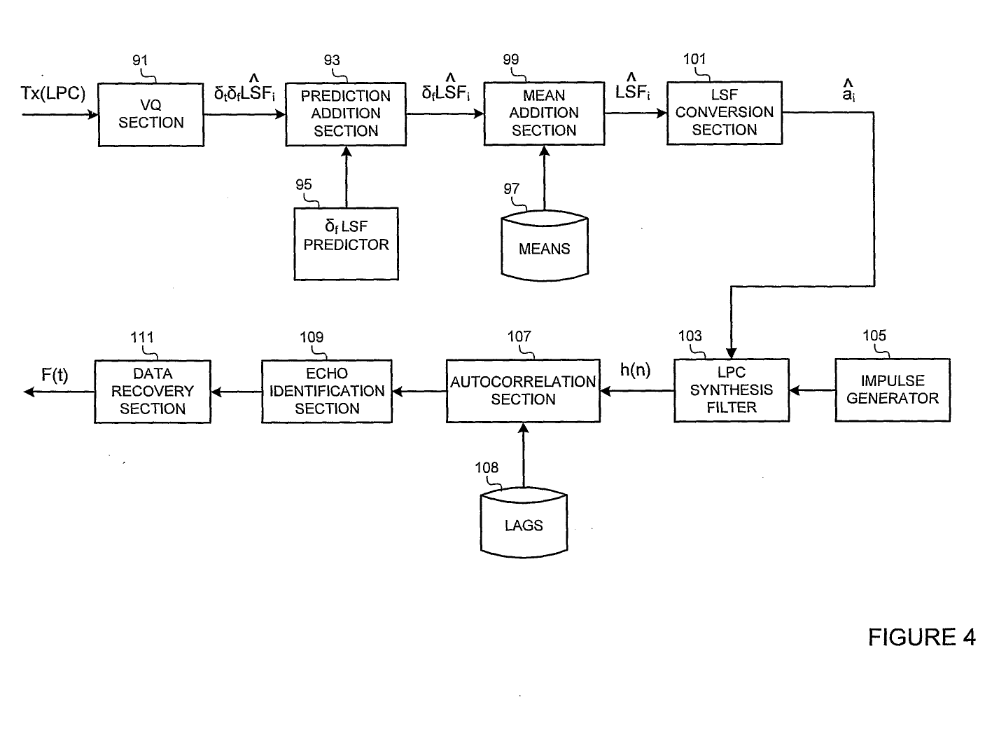

FIG. 4 is a schematic block diagram illustrating the processing performed on the output from the audio codec to recover data hidden within the audio signal;

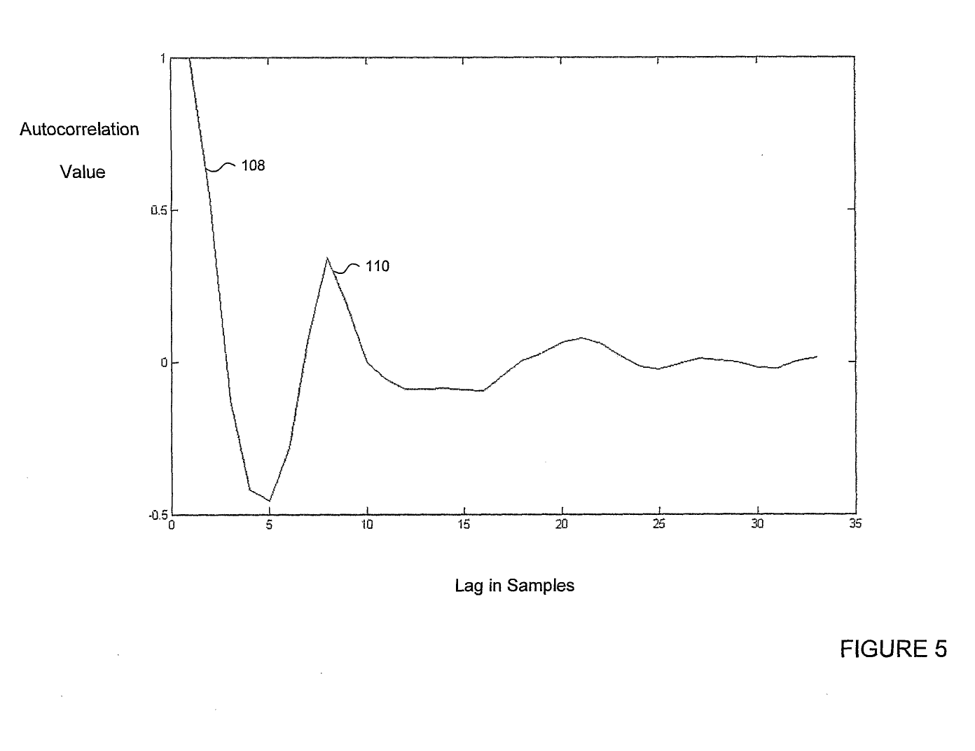

FIG. 5 is an autocorrelation plot from which the hidden data can be determined;

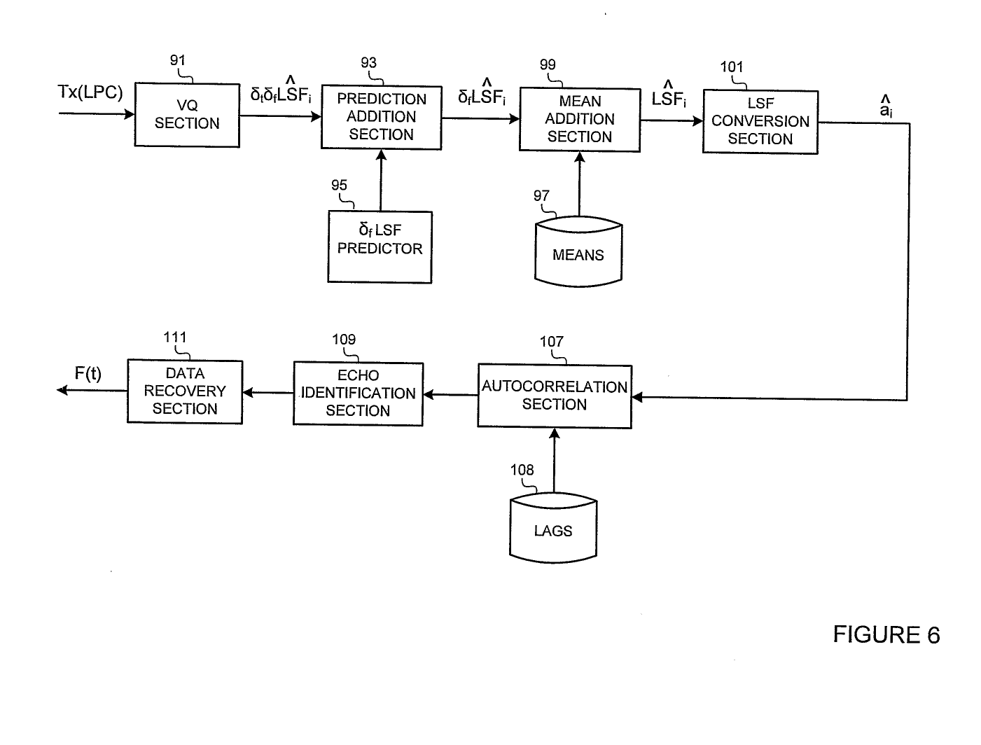

FIG. 6 is a block schematic diagram illustrating an alternative processing which can be performed to recover the hidden data;

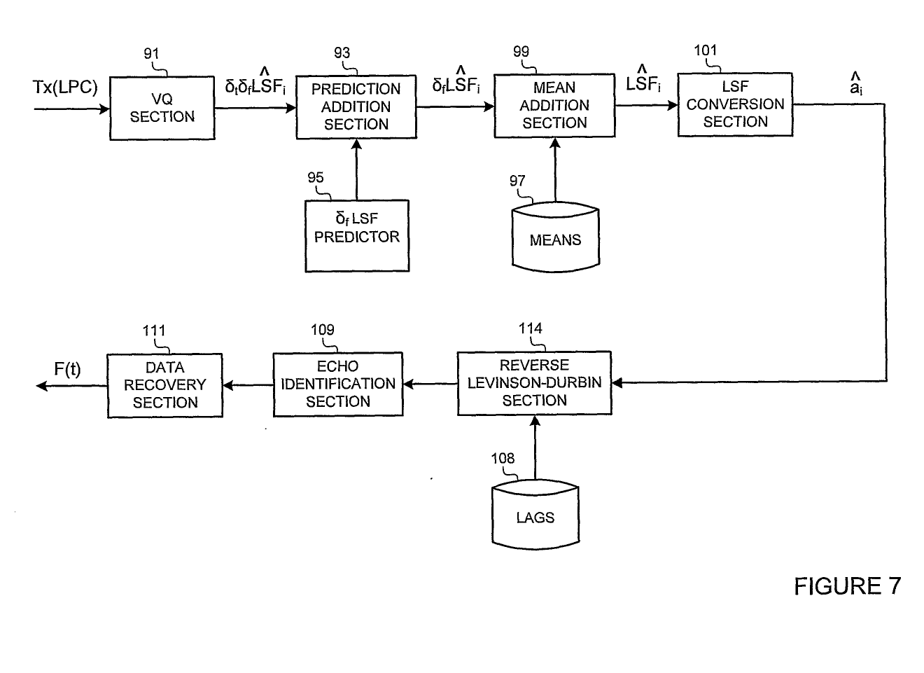

FIG. 7 is a block schematic diagram illustrating a further alternative way in which the hidden data may be recovered from the output from the audio codec;

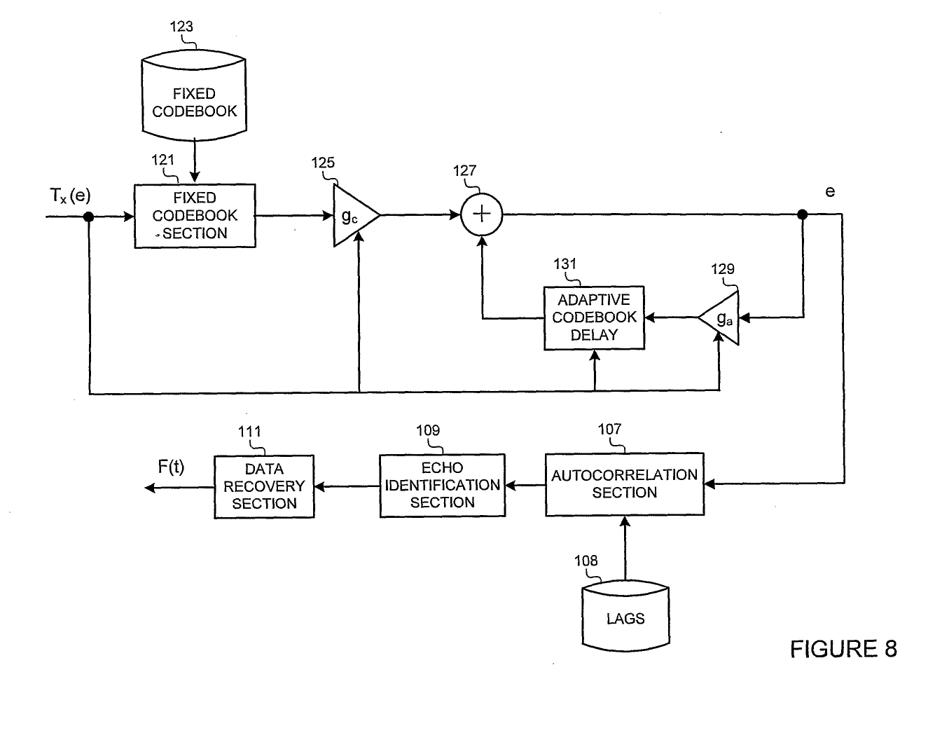

FIG. 8 is a block schematic diagram illustrating the way in which hidden data may be recovered from excitation parameters output by the audio codec;

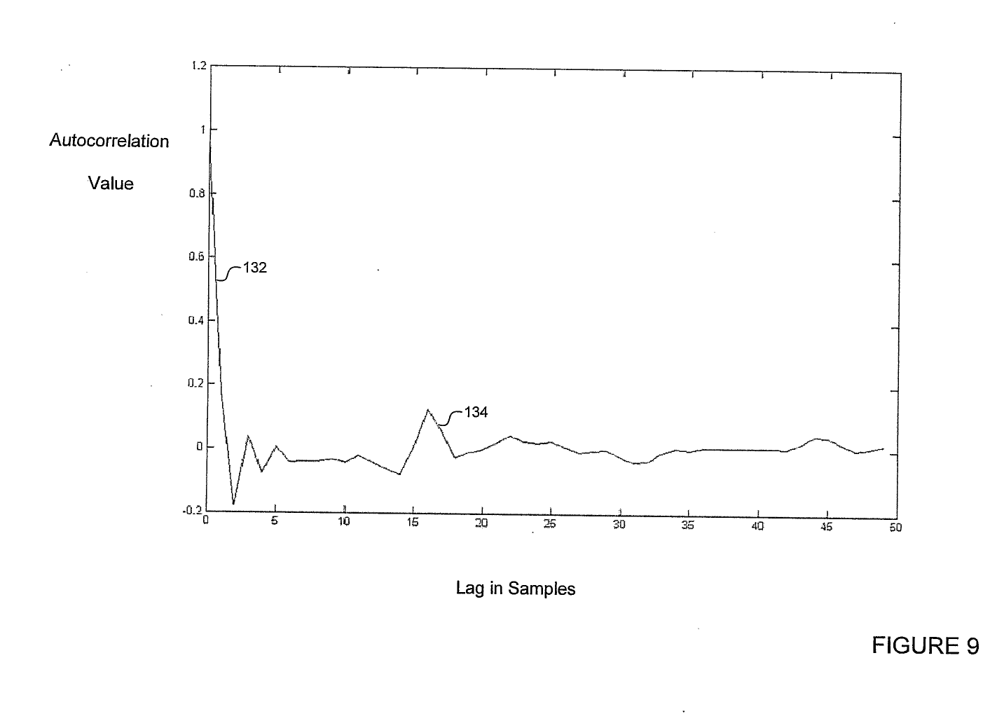

FIG. 9 is an autocorrelation plot output by the autocorrelation section forming part of the circuitry shown in FIG. 8, from which the hidden data can be identified;

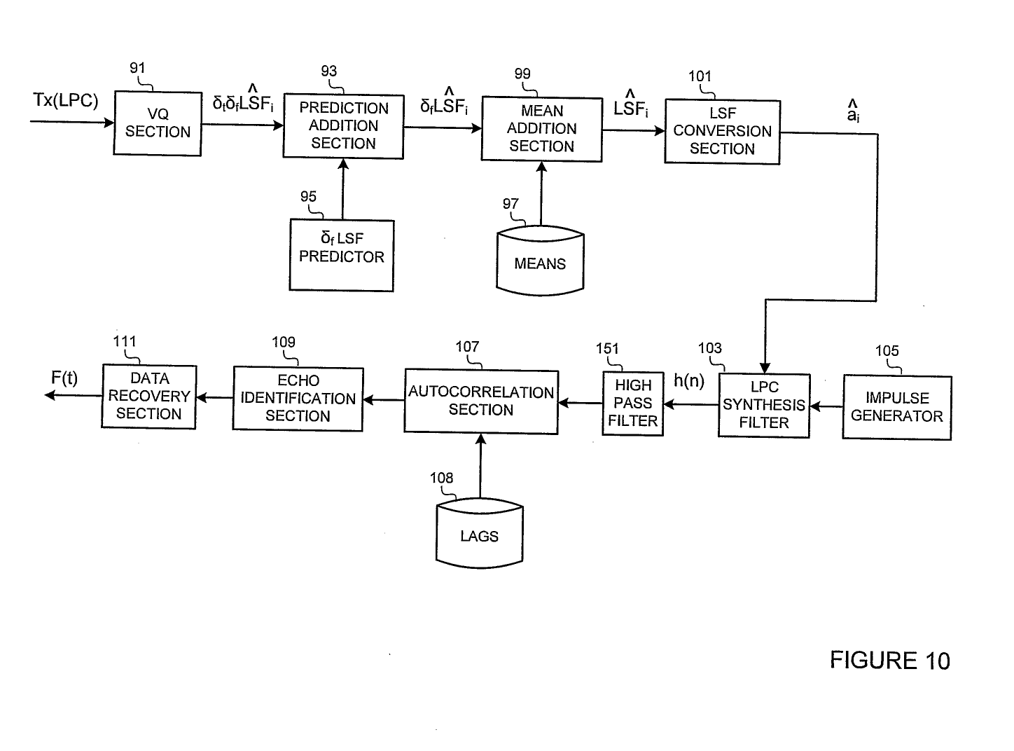

FIG. 10 is a block schematic diagram illustrating a refinement to the processing circuitry shown in FIG. 4, in which the impulse response of an LPC synthesis filter is high pass filtered to reduce the effects of low frequency audio components;

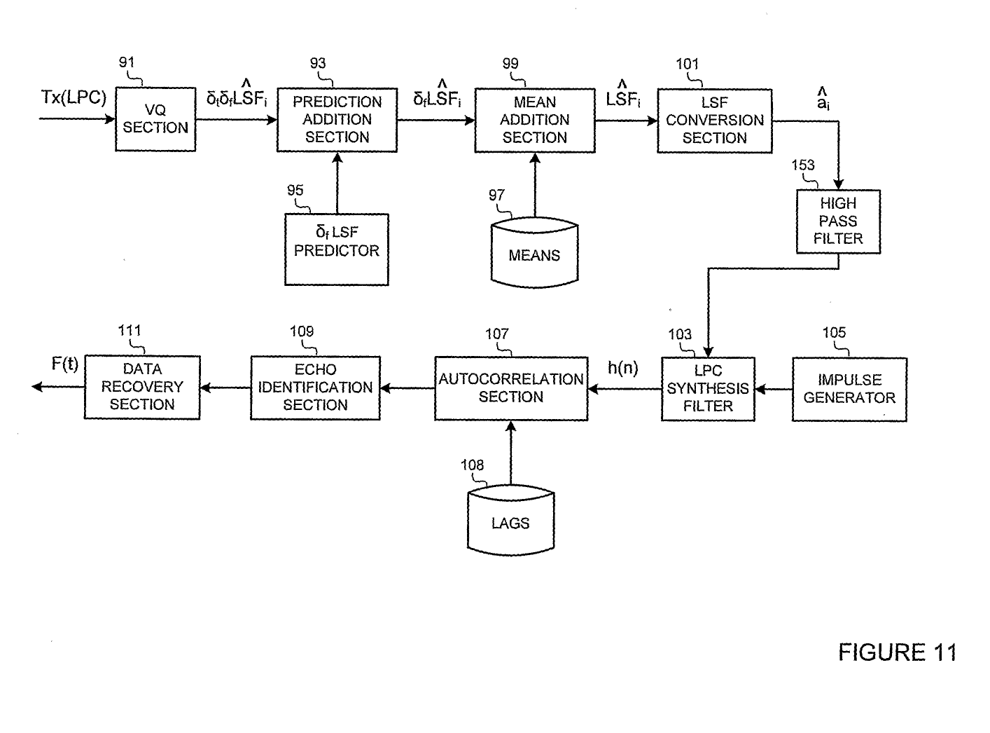

FIG. 11 is a block schematic diagram illustrating a further refinement of the processing circuitry shown in FIG. 4 in which the LPC coefficients are high pass filtered to remove lower order coefficients relating to lower frequency audio components;

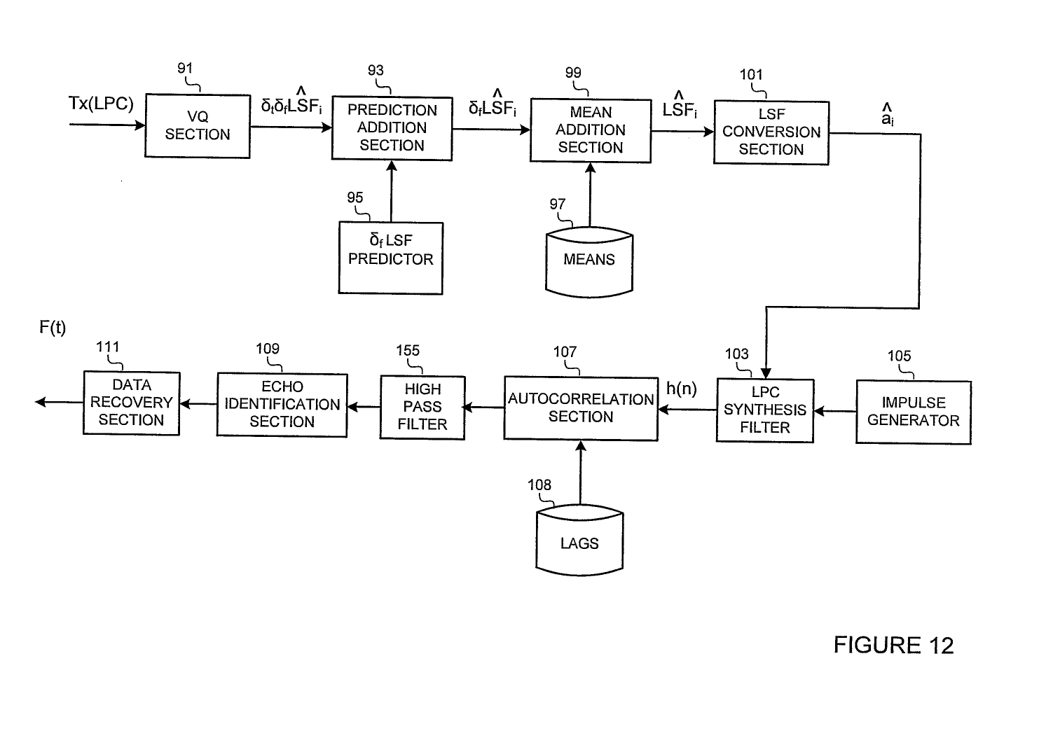

FIG. 12 illustrates a further refinement of the processing circuitry shown in FIG. 4 in which the autocorrelation plot illustrated in FIG. 5 is high pass filtered to remove slowly varying autocorrelations;

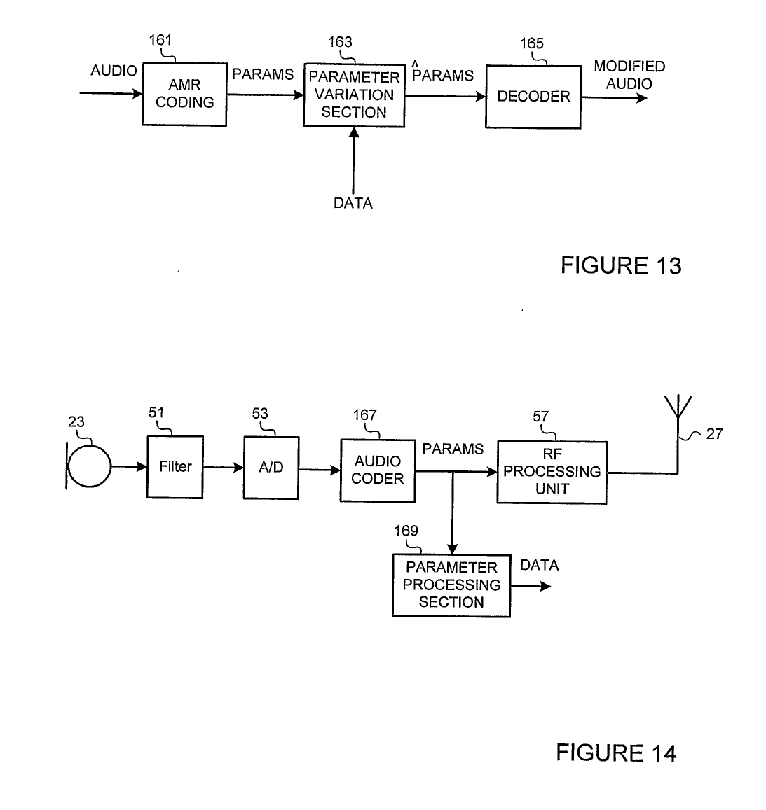

FIG. 13 is a general schematic block diagram illustrating one way in which the hidden data can be encoded within the audio prior to reception by the cellular telephone;

FIG. 14 is a general block diagram illustrating the way in which the cellular telephone recovers the data encoded using the system illustrated in FIG. 13;

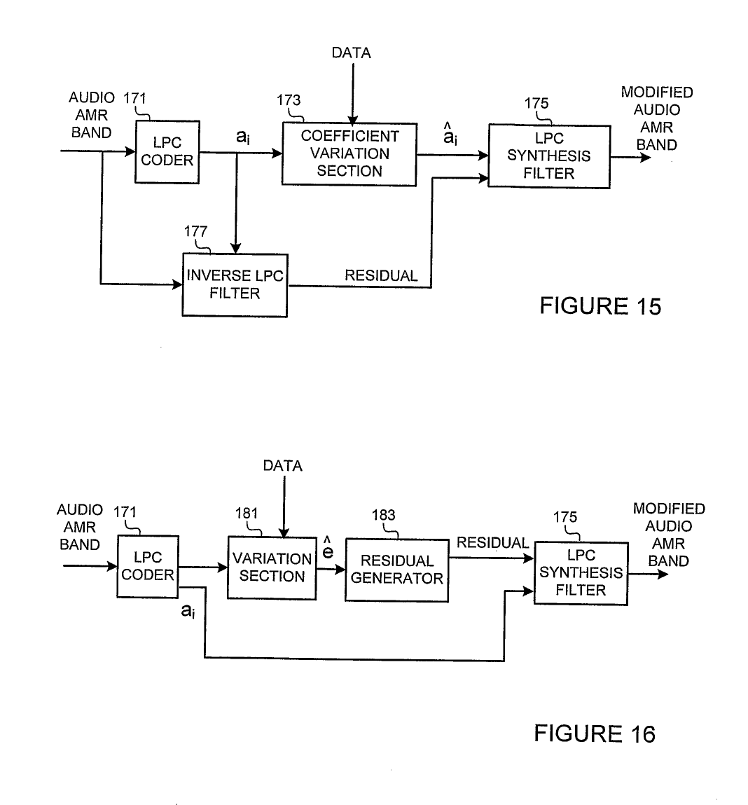

FIG. 15 is a block diagram illustrating one way in which the parameters generated by an LPC coder can be modified and recombined with a residual signal to form the modified audio for transmission to the cellular telephone; and

FIG. 16 illustrates an alternative way in which the excitation parameters obtained from an LPC coder are modified and from which a residual signal is generated for use in synthesising the modified audio with the LPC coefficients obtained from the LPC coder; and

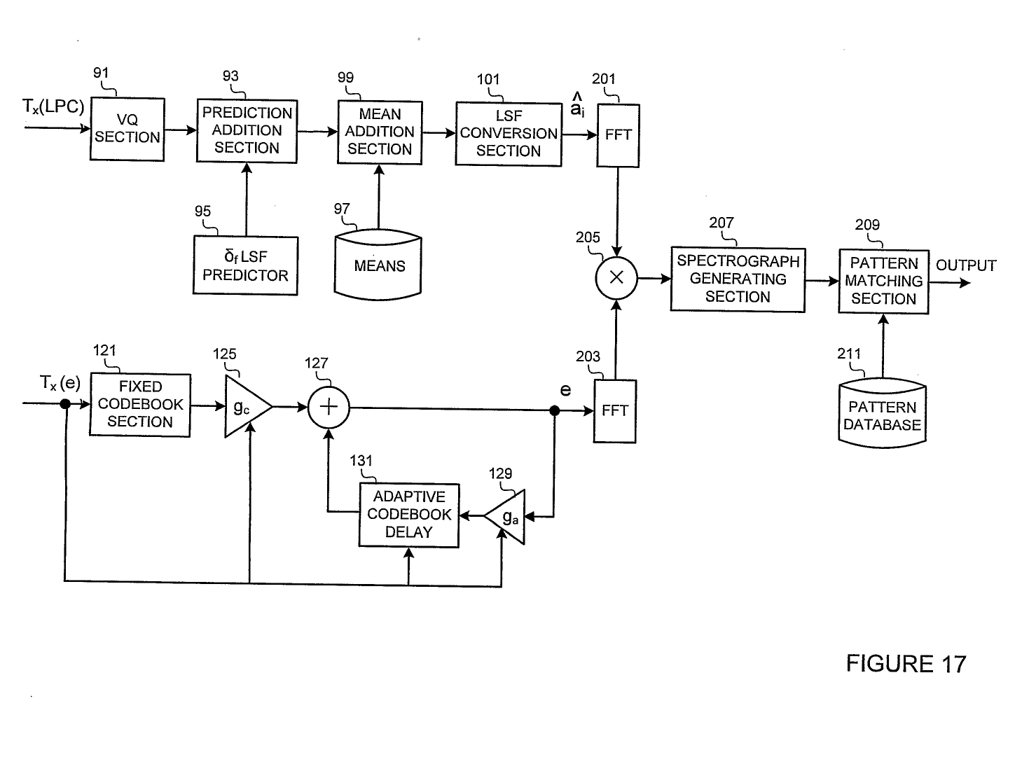

FIG. 17 is a block diagram illustrating the way in which the output of the audio codec can be processed to recover a spectrograph for the input audio for use in identifying or characterising the input audio signal.

### OVERVIEW

FIG. 1 illustrates a first embodiment of the invention in which a data signal F(t), generated by a data source 1, is encoded within an audio track from an audio source 3 by an encoder 5 to form a modified audio track for a television programme. In this embodiment, the data signal F(t) conveys trigger signals for synchronising the operation of a software application running on a user's mobile telephone 21 with the television programme. As shown in FIG. 1, the modified audio track output by the encoder 5 is then combined with the corresponding video track, from a video source 7, in a signal generator 9 to form a television signal conveying the television programme. In this embodiment, the data source 1, the audio source 3, the video source 7 and the encoder 5 are all located in a television studio and the television signal is distributed by a distribution network 11 and, in this embodiment, a radio frequency (RF) signal 13. The RF signal 13 is received by a television aerial 15 which provides the television signal to a conventional television 17. The television 17 has a display (not shown) for showing the video track and a loudspeaker not shown for outputting the modified audio track as an acoustic signal 19.

As shown, in this embodiment, the cellular telephone 21 detects the acoustic signal 19 emitted by the television 17 using a microphone 23 which converts the detected acoustic signal into a corresponding electrical signal. The cellular telephone 21 then decodes the electrical signal to recover the data signal F(t). The cellular telephone 21 also has conventional components such as a loudspeaker 25, an antenna 27 for communicating with a cellular base station 35, a display 29, a keypad 31 for entering numbers and letters and menu keys 33 for accessing menu options. The data recovered from the audio signal can be used for a number of different purposes, as explained in WO02/45273. One application is for the synchronisation of a software application running on the cellular telephone 21 with the television programme being shown on the television 17. For example, there may be a quiz show being shown on the television 17 and the cellular telephone 21 may be arranged to generate and display questions relating to the quiz shown in synchronism with the quiz show. The questions may, for example, be pre-stored on the cellular telephone 21 and output when a suitable synchronisation code is recovered from the data signal F(t). At the end of the quiz show, the answers input by the user into the cellular telephone 21 (via the keypad 31) can then be transmitted to a remote server 41 via the cellular telephone base station 35 and the telecommunications network 39. The server 41 can then collate the answers received from a large number of users and rank them based on the number of correct answer given and the time taken to input the answers. This timing information could also be determined by the cellular telephone 21 and transmitted to the server 41 together with the user's answers. As those skilled in the art will appreciate, the server 41 can also process the information received from the different users and collate various user profile information which it can store in the database 43. This user profile information may then be used, for example, for targeted advertising.

After the server 41 has identified the one or more “winning” users, information or a prize may be sent to those users. For example, a message may be sent to them over the telecommunications network 39 together with a coupon or other voucher. As shown by the dashed line 44 in FIG. 1, the server 41 may also provide the data source 1 with the data to be encoded within the audio.

As mentioned above, the inventors have realised that the processing required to be carried out by the software running on the cellular telephone 21 can be reduced by making use of the encoding being performed by the dedicated audio codec chip. In particular, the inventors have found that using the encoding process inherent in the audio codec as an initial step of the decoding process to recover the hidden data, reduces the processing required by the software to recover the hidden data.

### Cellular Telephone

FIG. 2 illustrates the main components of the cellular telephone 21 used in this embodiment. As shown, the cellular telephone 21 includes a microphone 23 for receiving acoustic signals and for converting them into electrical equivalent signals. These electrical signals are then filtered by the filter 51 to remove unwanted frequencies typically outside the frequency band of 300 Hz to 3.4 kHz (as defined in standard document EN300-903, published by ETSI). The filtered audio is then digitised by an analog to digital converter 53, which samples the filtered audio at a sampling frequency of 8 kHz, representing each sample typically by a 13 to 16 bit digital value. The stream of digitised audio (D(t)) is then input to the audio codec 55, which is an Adaptive MultiRate (AMR) codec, the operation of which is described below. The compressed audio output by the AMR codec 55 is then passed to an RF processing unit 57 which modulates the compressed audio onto one or more RF carrier signals for transmission to the base station 35 via the antenna 27. Similarly, compressed audio signals received via the antenna 27 are fed to the RF processing unit 57, which demodulates the received RF signals to recover the compressed audio data from the RF carrier signal(s), which are passed to the AMR codec 55. The AMR codec 55 then decodes the compressed audio data to regenerate the audio samples represented thereby, which are output to the loudspeaker 25 via the digital to analog converter 59 and the amplifier 61.

As shown in FIG. 2, the compressed audio data output from the AMR codec 55 (or the RF processing unit 57) is also passed to the processor 63, which is controlled by software stored in memory 65. The software includes operating system software 67 (for controlling the general operation of the cellular telephone 21), a browser 68 for accessing the internet and application software 69 for providing additional functionality to the cellular telephone 21. In this embodiment, the application software 69 is configured to cause the cellular telephone 21 to interact with the television programme in the manner discussed above. To do this, the application software 69 is arranged to receive and process the compressed audio data output from the AMR codec 55 to recover the hidden data F(t) which controls the application software 69. As will be described in more detail below, the processing of the compressed audio data to recover the hidden data F(t) can be performed without having to regenerate the digitised audio samples and whilst reducing the processing that would have been required by the software application 69 to recover the hidden data directly from the digital audio samples.

In response to recovering the hidden data, the application software 69 is arranged to generate and output data (eg questions for the user) on the display 29 and to receive the answers input by the user via the keypad 31. The software application 69 then transmits the user's answers to the remote server 41 (identified by a pre-stored URL, E.164 number or the like) together with timing data indicative of the time taken by the user to input each answer (calculated by the software application 69 using an internal timer (not shown)). The software application 69 may also display result information received back from the server 41 indicative of how well the user did relative to other users who took part in the quiz.

### AMR Codec

Although the AMR codec 55 is well known and defined by the 3GPP standards body (in Standards documentation TS 26.090 version 3.1.0), a general description of the processing it performs will now be given with reference to FIG. 3 in order that the reader can understand the subsequent description of the processing performed by the application software 69.

The AMR codec 55 (Adaptive-Multi-Rate coder-decoder) converts 8 kHz sampled-data audio, in the band 300 Hz to 3.4 kHz into a stream of bits at a number of different bit-rates. The codec 55 is therefore highly suited to situations where transmission rates may be required to vary. Its output bit-rate can be adapted to match the prevailing transmission conditions, and for this reason it is a 3G standard and currently used in most cellular telephones 21.

Although the bit-rate is variable, the same fundamental encoding processes are employed by the codec 55 at all rates. The quantisation processes, the selection of which parameters are to be transmitted and the rate of transmission are varied to achieve operation in the eight bit-rates or modes: 12.2, 10.2, 7.95, 7.40, 6.70, 5.90, 5.15 and 4.75 Kbits/s. In this embodiment the highest bit-rate mode is used (12.2 Kbits/s).

There are four major component sub-systems in the AMR codec 55 which are described below. They are:
Pitch prediction
LPC Analysis
Fixed codebook lookup
Adaptive codebook

The AMR codec 55 applies them in that order, although for present purposes it is easier to treat pitch prediction last and as part of the adaptive codebook processing. The AMR codec 55 is built around a CELP (Codebook Excited Linear Prediction) coding system. The input audio signal is divided into 160 sample frames (f) and the frames are subject to linear prediction analysis to extract a small number of coefficients per frame to code and transmit. These coefficients characterise the short-term spectrum of the signal within the frame. In addition to these coefficients, the AMR codec 55 also computes an LPC residual (also referred to as the excitation) which is coded using the adaptive and fixed codebooks assisted by the pitch predictor. These subsystems are described below.

### LPC Analysis

The LPC analysis is performed by the LPC analysis section 71 shown in FIG. 3a. LPC assumes the classical source-filter model of speech production (illustrated in FIG. 3b) in which speech is regarded as the output of a slowly time-varying filter (LPC synthesis filter 72), excited by regular glottal pulses for voiced speech, such as in vowels, and white noise for unvoiced speech, e.g. /sh/, or a mixture of the two for mixed-voice sounds, like /z/ (represented by the excitation block 74). Although based on a model of speech production, it also provides a valid model for encoding all sounds. The synthesis filter 72 is assumed to be all-pole, i.e. it has resonances only. This assumption is the basis of the LPC analysis method. In sampled data (z-plane) notation it means that the transfer function is purely a polynomial in z⁻¹ in the denominator of the transfer function, H(z).

$$H ( z ) = \frac{1.0}{A ( z )} = \frac{1.0}{{\sum }_{i = 1}^{p} {a}_{i} {z}^{- 1}} \qquad ( 1 )$$

The time series response sₙ of this filter to the input excitation eₙ is then:

$${s}_{n} = {e}_{n} + {\sum }_{i = 1}^{p} {a}_{i} {s}_{n - i} \qquad ( 2 )$$

which says that the output sₙ of the system is the input, eₙ plus a weighted linear sum of the p previous outputs. This is the theoretical basis of LPC. The limit. P is the LPC ‘order’ which is usually fixed and in the AMR codec 55 p is equal to ten. In the AMR codec 55 (and other LPC based systems) linear prediction analysis is employed to estimate the filter weights or coefficients, a for each frame of the input audio. Once estimated, they are then converted to a form suitable for quantising and transmission.

Estimating the coefficients aᵢ efficiently requires approximations and assumptions to be made. All methods of solving for the coefficients aim at minimising the contribution of the eₙ in equation (2) above. The AMR codec 55 uses the autocorrelation method, which means solving p simultaneous linear equations; in matrix form:

$$( \begin{matrix}R ( 0 ) & … & R ( p - 1 ) \\ ⋮ & ⋱ & ⋮ \\ R ( p - 1 ) & … & R ( 0 )\end{matrix} ) ( \begin{matrix}{α}_{1} \\ ⋮ \\ {α}_{P}\end{matrix} ) = ( \begin{matrix}R ( 1 ) \\ ⋮ \\ R ( p )\end{matrix} ) \qquad ( 3 )$$

Or in a more abbreviated form:

Rᵢⱼaᵢ=rᵢ (4)

The elements, rᵢⱼ of R are the autocorrelation values for the input audio signal at lag |i−j|. As R is symmetric and all elements of each diagonal are equal, it is open to quick recursive methods for finding its inverse. The Levinson-Durbin algorithm is used in the AMR coder 55.

### Line Spectral Frequencies

The coefficients aᵢ are actually not easy to quantise. They change fairly unpredictably with time and have positive and negative values over an undetermined range. The AMR codec 55 therefore uses a LSF determination section 73 to convert these coefficients to line spectral frequencies before quantising, which removes these disadvantages and allows for the efficient coding of the LPC coefficients. The coefficients aᵢ are the weights of the all-pole synthesis filter 72 and are the coefficients of a p^{th} order polynomial in z⁻¹, which can be factored to find its roots. These roots are the resonances or poles in the synthesis filter 72. These poles have often been quantised for transmission as they are reasonably ordered, have average values and change more predictably from frame to frame, which give opportunities for saving bits, which coding the aᵢ does not. Line spectral frequencies (LSFs) are even, better for this than the poles. It is important to realise LSFs are not the same as the poles of the all-pole model but they are related. Their derivation is involved, but qualitatively it involves choosing two sets of boundary conditions in a particular representation of the synthesis filter, one boundary condition corresponding to when the glottis is perfectly open and the other corresponding to when the glottis is perfectly closed. This results in two sets of hypothetical poles with zero bandwidth, i.e. perfect resonators.

The main advantages of LSFs are that:
LSFs consist of a frequency only, their bandwidth is always zero (although there are twice as many LSFs as there are poles)
LSFs are theoretically better ordered than poles

LSFs are thus amenable to very low bit-rate coding. In particular, as shown in FIG. 3a, the mean (computed in advance and stored in the data store 75) of each LSF can be subtracted by the mean subtraction section 77. Further, as the resulting delta LSF does not change quickly with time, a predictor 79 can then be used to predict the current delta value, which is subtracted from the actual delta by the prediction subtraction section 81. The resulting data are then additionally coded by a vector quantisation (VQ) section 83 which encodes two values at once via a single index, resulting in less than 1-bit per value in some cases. The AMR codec 55 outputs the VQ index values thus obtained for the current frame as the coded LPC data for transmission to the base station 35.

### LP Excitation

As mentioned above, the AMR codec 55 also encodes the excitation part 74 of the model illustrated in FIG. 3b. In order to do this, the AMR codec 55 generates a representation of the excitation signal so that it can then encode it. As illustrated in FIG. 3c, it does this by generating an “inverse” LPC filter 76 which can generate the excitation signal by filtering the input audio signal. The excitation signal obtained from the inverse filter 76 is sometimes also referred to as the residual. This inverse LPC filter 76 is actually defined from the same coefficients aᵢ determined above, but using them to define an all-zero model with the transfer function:

$$A ( z ) = 1.0 + {\sum }_{i = 1}^{p} {a}_{i} {z}^{- i} \qquad ( 5 )$$

This corresponds in the time-domain to a filter:

$${e}_{n} = {s}_{n} + {\sum }_{i = 1}^{p} {a}_{i} {s}_{n - i} \qquad ( 6 )$$

The inverse LPC filter 76 defined by (6) consists of zeros cancelling out the poles in the all-pole synthesis filter 72 defined by (2). In theory, if the input audio signal is filtered using the inverse filter 76 and then the generated excitation signal is filtered by the synthesis filter 72, then we arrive back at the input audio signal (hence the name “inverse” LPC filter). It is important to note that the original audio signal need not be speech for a perfect reconstruction to occur. If the LPC analysis has not done a good job in representing the input audio signal, then there will be more information in the residual.

It is the job of the fixed codebook section 87 and the adaptive codebook section 89 of the AMR codec 55 to code the excitation signal. A relatively large number of bits are used in the AMR codec 55 to code the excitation when compared to the number of bits used for coding the LSFs: 206 out of 244 bits per frame (84%) in 12.2 Kbits/s mode and 72 out of 95 (74%) in 4.75 kbits/s mode. It is this use of bits that allows the AMR codec 55 to code non-speech signals with some effect.

The excitation in voiced speech is characterised by a series of clicks (pulses) at the voice pitch (about 100 Hz to 130 Hz for an adult male in normal speech, twice that for females and children). In unvoiced speech it is white noise (more or less). In mixed speech it is a mixture. One way of thinking about the excitation as the residual is to realise that the LPC analysis takes out the bumps in the audio's short-term spectrum, leaving a residual with a much flatter spectrum. This applies whatever is the input signal.

In the AMR codec 55 the excitation signal is coded as the combination of a fixed codebook and an adaptive codebook output. The adaptive codebook does not exist as anything to look up, but is a copy of the previous combinations of the combined codebook outputs fed back at the period predicted by the pitch predictor.

### The Fixed Codebook

The fixed codebook section 87 generates the excitation signal (e_{f}) for the current frame by using the LPC coefficients aᵢ output from the LPC analysis section 71 for the current frame, to set the weights of the inverse filter 76 defined in equation (6) above; and by filtering the current frame of the input audio with this filter. The fixed codebook section then identifies the fixed codebook pulses or patterns (stored in the fixed codebook 88) which best cater for new things happening in the excitation signal, which will effectively modify the lagged (delayed) copy of the previous frame's excitation from the adaptive codebook section 89.

Each frame is subdivided into four sub-frames each of which has an independently coded fixed-codebook output. The fixed-codebook excitation for one sub-frame codes the excitation as a series of 5 interleaved trains of pairs of unity amplitude pulses. The possible positions for each pair of pulses are shown in the table below for MR122 (the name of the AMR's 12.2 kb/s mode). As indicated above this coding uses a significant number of bits.

| Track | Pulse | Positions |
|---|---|---|
| 1 | 0, 5 | 0, 5, 10, 15, 20, 25, 30, 35 |
| 2 | 1, 6 | 1, 6, 11, 16, 21, 26, 31, 36 |
| 3 | 2, 7 | 2, 7, 12, 17, 22, 27, 32, 37 |
| 4 | 3, 8 | 3, 8, 13, 19, 23, 28, 33, 38 |
| 5 | 4, 9 | 4, 9, 14, 19, 24, 29, 34, 39 |

The sign of the first pulse in each track is also coded; the sign of the second pulse is the same as the first unless it falls earlier in the track when it is opposite. The gain for the sub frame is also coded.

### The Adaptive Codebook

The adaptive codebook is a time delayed copy of the previous portion of the combined excitation and is important in coding voiced speech. Because voiced speech is regular, it is possible to code only the difference between the current pitch period and the previous using the fixed codebook output. When added to a saved copy of the previous voice period, we get the estimate of this frame's excitation. The adaptive codebook is not transmitted; the coder and decoder calculate the adaptive codebook from the previous combined output and the current pitch delay.

### Pitch Predictor

The purpose of the pitch predictor (which forms part of the adaptive codebook section 89) is to determine the best delay to use for the adaptive codebook. It is a two stage process. The first is a single pass, open loop pitch prediction that correlates the speech with previous samples to find an estimate of the voiced period if the speech is voiced or the best repetition rate that minimises an error measure. This is followed by a repeated closed-loop prediction to get the best delay for the adaptive codebook within ⅙^{th} of a sample. For this reason pitch prediction is part of the adaptive codebook process in the coder. The calculation is limited by the two stage approach as the second more detailed search only happens over a small number of samples. The AMR codec 55 uses an analysis by synthesis approach, so selects the best delay by minimising the mean-square-error between outputs and the input speech for candidate delays.

Therefore, to represent the excitation signal for the current frame, the AMR codec 55 outputs the fixed codebook indices (one for each sub-frame) determined for the current frame, the fixed codebook gain, the adaptive codebook delay and the adaptive codebook gain. It is this data and the LPC encoded data that is made available to the application software 69 running on the cellular telephone 21 and from which the hidden data has to be recovered.

### Data Hiding and Recovery

There are various ways in which the data F(t) can be hidden within the audio signal and the reader is referred to the paper by Bender entitled “Techniques For Data Hiding”, IBM Systems Journal, Vol 35, no 384, 1996, for a detailed discussion of different techniques for hiding data in audio. In the present embodiment, the data is hidden in the audio by adding an echo to the audio, with the time delay of the echo being varied to encode the data. This variation may be performed, for example by using a simple no echo corresponds to a binary zero and an echo corresponds to a binary one scheme. Alternatively, a binary one may be represented by the addition of an echo at a first delay and a binary zero may be represented by the addition of an echo at a second different delay. The sign of the echo can also be varied with the data to be hidden. In a more complex encoding scheme a binary one may be represented by a first combination or sequence of echoes (two or more echoes at the same time or applied sequentially) and a binary zero may be represented by a second different combination or sequence of echoes.

In this embodiment, echoes can be added with delays of 0.75 ms and 1.00 ms and a binary one is represented by adding an attenuated 0.75 ms echo for a first section of the audio (typically corresponding to several AMR frames) followed by adding an attenuated 1.00 ms echo in a second section of the audio; and a binary zero is represented by adding an attenuated 1.00 ms echo for a first section of the audio followed by adding an attenuated 0.75 ms echo in a second section of the audio. Therefore, in order to recover the hidden data, the software application has to process the encoded output from the AMR codec 55 to identify the sequences of echoes received in the audio and hence the data hidden in the audio.

Typically, echoes are identified in audio signals by performing an autocorrelation of the audio samples and identifying the peaks corresponding to any echoes. However, as mentioned above, the hidden data is to be recovered from the output of the AMR codec 55.

### Data Recovery 1

FIG. 4 illustrates one way in which the echoes can be detected and the hidden data F(t) recovered by the application software 69 from the output of the AMR codec 55. As shown, in this technique, the application software recovers the hidden data solely from the LPC encoded information output by the VQ section 83 shown in FIG. 3. As illustrated in FIG. 4 the first processing performed by the application software 69 is performed by the VQ section 91, which reverses the vector quantisation performed by the AMR codec 55. The output of the VQ section 91, is then processed by the prediction addition section 93, which adds the LSF delta predictions (determined by the predictor 95) to the outputs from the VQ section 91. The LSF means (obtained from the data store 97) are then added back by the mean addition section 99, to recover the LSFs for the current frame. The LSFs are then converted back to the LPC coefficients by the LSF conversion section 101. The thus determined coefficients a, will not be exactly the same as those determined by the LPC analysis section 71 in FIG. 3, due to the approximations and quantisation performed in the other AMR processing stages.

As shown, in this embodiment, the determined LPC coefficients a, are used to configure an LPC synthesis filter 103 in accordance with equation (2) above. The impulse response (h(n)) of this synthesis filter 103 is then obtained by applying an impulse (generated by the impulse generator 105) to the thus configured filter 103. The inventors have found that the echoes are present within this impulse response (h(n)) and can be found from an autocorrelation of the impulse response around the lags corresponding to the delay of the echo. As shown, the autocorrelation section 107 performs these autocorrelation calculations for the lags identified in the data store 108. FIG. 5 illustrates the autocorrelation obtained for all positive lags. The plot identifies the lags as samples from the main peak 108 at zero lag. So with an 8 kHz sampling rate, each sample corresponds to a lag of 0.125 ms. As shown, there is an initial peak 108 at zero lag, followed by a peak 110 at a lag of about 1.00 ms (corresponding to 8 samples from the origin)—indicating that the current frame has a 1.00 ms echo. As those skilled in the art will appreciate, there is no need to calculate the autocorrelation for all lags—just those around the lags corresponding to where the echoes are to be found (ie around 0.75 ms and 1.00 ms).

As shown in FIG. 4, the autocorrelation values determined by the autocorrelation section 107 are passed to an echo identification section 109, which determines if there are any echoes in the current frame (for example, by thresholding the autocorrelation values with a suitable threshold to identify any peaks at the relevant lags). Identified peaks are then passed to the data recovery section 111, which tracks the sequence of identified echoes over neighbouring frames to detect the presence of a binary one or a binary zero of the hidden data F(t). In this way, the hidden data is recovered and can then be used to control the operation of the application software 69 in the manner described above.

The inventors have found that the computational requirements to recover the hidden data in this way is significantly less than would be required by recovering the hidden data directly from the digitised audio samples.

### Data Recovery 2

In the embodiment described above, the autocorrelation of the LPC synthesis filter's impulse response was determined and from which the presence of the echoes was determined to recover the hidden data. FIG. 6 illustrates the processing that can be performed according to an alternative technique for recovering the hidden data. As can be seen by comparing FIGS. 4 and 6, the main difference between this embodiment and the first embodiment is that the regenerated LPC coefficients âᵢ for the current frame are directly passed to the autocorrelation section 107, which calculates the autocorrelation of the sequence of LPC coefficients. This embodiment is therefore a simplification of the first embodiment. However, the peaks in the autocorrelation output at the echo lags are not as pronounced as in the first embodiment and so for this reason this simpler embodiment is not preferred where sufficient processing power is available.

### Data Recovery 3

FIG. 7 illustrates the processing that can be performed in a third technique for identifying the presence of echoes and the subsequent recovery of the hidden data. As can be seen by comparing FIGS. 6 and 7, the main difference between this embodiment and the second embodiment is that the regenerated LPC coefficients âᵢ for the current frame are applied to a reverse Levinson-Durbin section 114, which uses the reverse Levinson-Durbin algorithm to re-compute the autocorrelation matrix Rᵢⱼ of equation (3) above from the LPC coefficients. The values determined correspond to the autocorrelation values of the input audio signal itself and will, therefore, include peaks at lags corresponding to the delay of the or each echo. The output from the reverse Levinson-Durbin section 114 can therefore be processed as before, to recover the hidden data. The main disadvantage of this embodiment is that the reverse Levinson-Durbin algorithm is relatively computationally intensive and so where there is limited processing power, this embodiment is not preferred.

### Data Recovery 4

In the above three embodiments, the hidden data is recovered by processing the encoded LPC filter data output from the AMR codec 55. The AMR codec 55 will encode the echoes in the LPC filter data provided the echo delay is less than the length of the LPC filter. As mentioned above, the LPC filter has an order (p) of ten samples. With an 8 kHz sampling frequency, this corresponds to a maximum delay of 1.25 ms. If an echo with a longer delay is added, then it can not be encoded into the LPC coefficients. It will, however, be encoded within the residual or excitation signal. To illustrate this, an embodiment will be described in which the binary ones and zeros are encoded in the audio using 2 ms and 10 ms echoes.

FIG. 8 illustrates the processing performed in this embodiment by the application software 69, to recover the hidden data. As shown, in this embodiment, the application software 69 receives the excitation encoded data for each frame as it is output by the AMR codec 55. The fixed codebook indices in the received data are used, by the fixed codebook section 121, to identify the excitation pulses for the current frame from the fixed codebook 123. These excitation pulses are then amplified by the corresponding fixed gain defined in the encoded data received from the AMR codec 55. The amplified excitation pulses are then applied to an adder 127, where they are added to suitably amplified and delayed versions of previous excitation pulses obtained by passing the previous frame's excitation pulses through the gain 129 and an adaptive codebook delay 131. The adaptive codebook gain and delay used are defined in the encoded data received from the AMR codec 55. The output from the adder 127 is a pulse representation of the residual or excitation signal for the current frame. As shown in FIG. 8, this pulse representation (eᵢ) of the excitation signal is then passed to an autocorrelation section 107 which calculates its autocorrelation for the different lags defined in the lags data store 108. FIG. 9 illustrates the autocorrelation output from the autocorrelation section 107 for all positive lags, when there is a 2 ms echo in the received audio. As shown, there is a main peak 132 at a zero lag and another peak 134 at a lag corresponding to 2 ms. Therefore, the output of the autocorrelation section 107 can be processed as before by the echo identification section 109 and the data recovery section 111 to recover the hidden data F(t).

### Refinements

A number of refinements to the embodiments described above will now be described with reference to FIGS. 10, 11 and 12. These refinements have been made to increase the successful recovery of the hidden data and aim to combat the effects of speech or room acoustics that can mask the presence of the echoes. These refinements will be applied to the first embodiment described above, but they could equally well be applied to the other embodiments.

As can be seen by comparing FIGS. 4 and 10, in the first refinement, the impulse response (h(n)) of the LPC synthesis filter 103 for the current frame is filtered by a high pass filter 151 to reduce the effect of the lower frequencies in the impulse response. The inventors have found that the echo information is typically encoded into the higher frequency band of the impulse response. This high pass filtering therefore improves the sharpness of the autocorrelation peaks for the echoes, making it easier to identify their presence. The high pass filter 151 preferably filters out frequencies below about 2 kHz (corresponding to a frequency of a quarter of the sampling frequency) although some gain can still be made by filtering out only frequencies below about 1 kHz. As those skilled in the art will appreciate, this filtering is an “intra” frame filtering (ie filtering within the frame only) that filters out the low frequency part of the impulse response, although “inter” frame filtering (eg to filter out slowly varying features of the impulse response that occur between frames) could also be performed.

FIG. 11 illustrates an alternative way of achieving the same result. In particular, in this embodiment, the LPC coefficients âᵢ for the current frame are passed through a high pass filter 153 before being used to configure the LPC synthesis filter 103. In this case, the high pass filter 153 removes the coefficients corresponding to the lower frequency poles of the synthesis filter 103. This is achieved by factoring the LPC coefficients to identify the pole frequencies and bandwidths. Poles at frequencies below the lower limit are discarded and the remaining poles are used to generate a higher frequency-only synthesis filter 103. The remaining processing is as before, and a further description will not be given. As those skilled in the art will appreciate, this filtering is also an intra frame filtering, although inter frame filtering could also be performed.

FIG. 12 illustrates a further refinement that can be applied to increase the success rate of recovering the hidden data. As shown, the main difference between this embodiment and the embodiment shown in FIG. 4 is in the provision of a high pass filter 155 for performing inter frame filtering to filter out slowly varying correlations (ie correlations that vary slowly from frame to frame) in the autocorrelation output that are typically caused by the audio itself and the acoustics of the room in which the user's cellular telephone 21 is located. In addition to or instead of filtering out such inter frame variations, the high pass filter 155 could perform intra frame filtering to remove low frequency correlations from the autocorrelation output within each frame. This has been found to sharpen the correlation peaks caused by the echoes thereby making them easier to identify.

### General Encoding Scheme

In the above embodiments, data has been hidden within an audio signal by adding echoes having different delays. As those skilled in the art will appreciate, there are various ways in which the data may be hidden within the audio and still be passed through the AMR codec 55. In general terms, the above data hiding and recovery processes may be represented by the general block diagrams shown in FIGS. 13 and 14 respectively. As shown in FIG. 13, the general data hiding process can be considered to involve a similar coding operation 161 to that performed by the AMR codec, to generate the AMR parameters (which may be the final AMR output parameters or intermediate parameters generated in the AMR processing). One or more of these parameters are then varied 163 in dependence upon the data to be hidden within the audio. The modified parameters are then decoded 165 to generate a modified audio signal which is transmitted as an acoustic signal and received by the cellular telephone's microphone 23. After filtering and analog to digital conversion, the audio coder 167 then processes the digitised audio samples in the manner described above to generate the modified parameters. The modified parameters are then processed by the parameter processing section 169 to detect the modification(s) that were made to the parameters and so recover the hidden data.

In the case of adding echoes to the audio to encode the hidden data, this can easily be done in the manner described above without having to perform the detailed encoding process in the television studio (or wherever the data is to be hidden within the audio). Alternatively, the echoes could be added by manipulating the output parameters or intermediate parameters of the AMR coding process. For example, the echoes could be added to the audio by adding a constant to one or more entries of the autocorrelation matrix defined in equation (3) above or by directly manipulating the values of one or more of the LPC coefficients determined from the LPC analysis.

The data may also be hidden by other more direct ways of modulating the audio coding parameters. For example, the line spectral frequencies generated for the audio may be modified (by for example varying the least significant bit of the LSFs with the data to be hidden), or the frequency or bandwidth of the poles from which the LSFs are determined may be modified in accordance with the data to be hidden. Alternatively still, the excitation parameters may be modified to carry the hidden data. For example, the AMR codec 55 encodes the excitation signal using fixed and adaptive codebooks which define a train of pulses, with variable pulse positions and signs. Therefore, the data could be hidden by varying the least significant bit of the pulse positions within one or more of the tracks or sub-frames or by changing the sign of selected tracks or sub-frames.

Instead of applying echoes to hide the data in the audio, the phase of one or more frequency components of the audio signal may be varied in dependence upon the data to be hidden. The phase information from the audio is retained to a certain extent in the position of the pulses encoded by the fixed and adaptive codebooks. Therefore, this phase encoding can be detected from the output of the AMR codec 55 by regenerating the excitation pulses from the codebooks and detecting the phase changes of the relevant frequency component(s) with time.

As those skilled in the art will appreciate, it would be very unlikely that the studio system would use the actual AMR encoder and decoder model, as the audio quality in the television studio will be much greater than that used in the AMR codec 55. A full studio system would, therefore, split the audio band into an AMR band (between 300 Hz and 3.4 kHz) and a non-AMR band outside this range. It would then manipulate the AMR band as indicated above, but would not reconstruct the AMR-band signal using the AMR decoder. Instead it would synthesise the AMR band audio signal from the actual LPC residual obtained from the original audio signal and the modified LPC data, to yield higher audio quality. Alternatively, where the excitation parameters are modified with the hidden data, a residual would be constructed from the modified parameters which would then be filtered by the synthesis filter using the LPC coefficients obtained from the LPC analysis. The modified AMR band would then be added to the non-AMR band for transmission as part of the television signal. This processing is illustrated in FIGS. 15 and 16.

In particular, FIG. 15 illustrates the processing that may be performed within the television studio after the original audio has been split into the AMR band and the non-AMR band. As shown, the audio AMR band is input to an LPC coder 171 which performs the above-described LPC analysis to generate the LPC coefficients aᵢ for the current frame. These coefficients are then passed to a coefficient variation section 173 which varies one or more of these coefficients in dependence upon the data to be hidden within the audio signal. The modified LPC coefficients a, are then output to configure an LPC synthesis filter 175 in accordance with equation (2) given above. As shown in FIG. 15, the LPC coefficients a; generated by the LPC coder 171 are used to configure an inverse LPC filter 177 in accordance with equation (6) above. The frame of audio from which the current set of LPC coefficients are generated is then passed through this inverse LPC filter to generate the LPC residual (excitation) signal which is then applied to the LPC synthesis filter 175. This results in the generation of a modified audio AMR band signal which is then combined with the non-AMR band signal before being combined with the video track for distribution.

FIG. 16 illustrates the alternative scenario where the excitation parameters are varied with the data to be hidden. In particular, as shown in FIG. 16, the audio AMR band is initially processed by an LPC coder 171, which in this embodiment generates and outputs the fixed and adaptive codebook data representing the residual or excitation signal. This codebook data is then passed through a variation section 181, which varies the codebook data in order to change the position and/or sign of one or more pulses represented by the fixed codebook data in accordance with the data to be hidden within the audio signal. The modified codebook data is then output to a residual generator 183 which regenerates a corresponding residual signal that will, when processed by the AMR codec 55 regenerate the modified fixed and adaptive codebook data. This may be achieved, for example, by performing an iterative routine to adapt a starting residual until the coding of it results in the modified codebook data output by the variation section 181. Alternatively, the modified codebook data may be used to generate the pulse trains which are used directly as the residual signal. The gaps between the pulses may be filled with noise or part of the residual signal that can be generated using the inverse LPC filter and the LPC coefficients for the current frame. Regardless of the technique employed, the thus generated residual signal is then passed to the LPC synthesis filter 175 which is configured using the LPC coefficients generated by the LPC coder 171. The LPC synthesis filter 175 then filters the applied residual signal to generate the modified audio AMR band which is then combined with the non-AMR band to regenerate the audio for combination with the video track.

### Audio Identification

In the above embodiments, data was hidden within the audio of a television programme and this data was recovered by suitable processing in a cellular telephone. The processing performed to recover the hidden data utilises at least part of the processing that is already carried out by the audio codec of the cellular telephone. As mentioned above, the inventors have found that this reduces the computational overhead required to recover the hidden data. Similar advantages can be obtained in other applications where there is no actual data hidden within the audio but in which, for example, the audio is to be identified from acoustic patterns (fingerprint) of the audio itself. The way in which this can be achieved will now be described with reference to a music identification system.

At present, there are a number of music identification services, such as the one provided by Shazam. These music identification services allow users of cellular telephones 21 to identify a music track currently playing by dialing a number and playing the music to the handset. The services then text back the name of the track to the telephone. Technically, the systems operate by setting up a telephone call from the cellular telephone to a remote server whilst playing the music to the telephone. The remote server drops the call after a predetermined period, performs some matching on the received sound against patterns stored in a database to identify the music and then sends a text message to the telephone with the title of the music track it identified.

From published material from the inventors of the Shazam system and others, the general process used to identify tracks is:
1. Convert the raw audio signal into a spectrograph, which is usually achieved by calculating a series of overlapping Fast Fourier Transforms (FFTs).
2. Analyse the spectrograph to determine characteristic features—these are normally the positions of peaks of energy, characterised by their time and frequency.
3. Use a hash function of these features and use the result of the hash function to look up a database to determine a set of entries that may match the audio signal.
4. Perform further pattern matching against these potential matches to determine if the audio signal is really a match to any of those indentified from the database.

Conventionally, the spectrograph for the audio is determined from a series of Fast Fourier Transforms on overlapping blocks of digitised audio samples for the audio signal. When operating over the mobile telephone network, the input audio will be compressed by the AMR codec in the cellular telephone for transmission over the air interface 37 to the mobile telephone network 35, where the compressed audio is decompressed to regenerate the digital audio samples. The server then performs the Fourier Transform analysis on the digital audio samples to generate the spectrograph for the audio signal.

The inventors have realised that this encoding and decoding performed by the mobile telephone system and then the subsequent frequency analysis performed by the Shazam server is wasteful and that a similar system can be implemented without having to decode the compressed audio back to audio samples. In this way, the track recognition processing may be performed entirely within the cellular telephone 21. The user does not, therefore, have to place a call to a remote server to be able to identify the track that is being played. The way in which this is achieved will now be described with reference to FIG. 17.

In particular, FIG. 17 is a block diagram illustrating the processing performed by a track recognition software application (not shown) running on the cellular telephone 21. As shown, in this embodiment, the software application receives the AMR encoded LPC data and the AMR encoded excitation data from the AMR codec 55. The AMR LPC encoded data is then passed to the VQ section 91, prediction addition section 93, mean addition section 99 and LSF conversion section 101 as before. The result of this processing is the regenerated LPC coefficients aᵢ. The LPC coefficients for the current frame are then passed to an FFT section 201 which calculates their Fast Fourier Transform.

Similarly, the AMR encoded excitation data is decoded by the fixed codebook section 121, the fixed gain 125, the adder 127, the adaptive codebook delay 121 and the adaptive gain 129, to regenerate the excitation pulses representing the residual for the input frame. These decoded pulses are then input to the FFT section 203 to generate the Fourier transform of the excitation pulses. As shown in FIG. 17, the outputs from the two FFT sections 201 and 203 are multiplied together by the multiplier 205 to generate a combined frequency representation for the current frame. This combined frequency representation output by the multiplier 205 should correspond approximately to the FFT of the digital audio samples within the current frame. This is because of the source-filter model underlying the LPC analysis performed by the AMR codec 55. In particular, as described above, the LPC analysis assumes that the speech is generated by filtering an appropriate excitation signal through a synthesis filter. In other words, the audio is generated by convolving the excitation signal with the impulse response of the synthesis filter, or in the frequency domain, by multiplying the spectrum of the excitation signal with the spectrum of the LPC synthesis filter.

In the present embodiment, the spectrum of the LPC coefficients is multiplied with the spectrum of the codebook excitation pulses. These are approximations to the spectrum of the LPC synthesis filter and the spectrum of the excitation signal respectively. Therefore, the combined spectrum output from the multiplier 205 will be an approximation of the spectrum of the digitised audio signal within the current frame. As shown in FIG. 17, this spectrum is then input to a spectrograph generating section 207 which generates a spectrograph from the spectrums received for adjacent frames of the input audio signal. The spectrograph thus generated is then passed to a pattern matching section 209 where characteristic features from the spectrograph are used to search patterns stored within a pattern database 211 to identify the audio track being picked up by the cellular telephone's microphone 23. As those skilled in the art will appreciate, this pattern matching may employ similar processing techniques to those employed in the server of the Shazam system, i.e. using a hash function first to identify a portion of the pattern database 211 to match with the audio's spectrograph. The identified track information output by the pattern matching section 209 is then output for display to the user on the display 29.

The inventors have found that this processing requires significantly less computation than converting the compressed audio data back to digitised audio samples and then taking the Fast Fourier Transform of the audio samples. Indeed, the inventors found that this processing requires less processing than taking the Fast Fourier Transforms of the original audio samples. This is because, taking the Fast Fourier Transform of the LPC coefficients is relatively simple as there are only ten coefficients per frame and because the Fast Fourier Transform of the codebook excitation pulses is also relatively straightforward as the pulse position coefficients can be transformed into the frequency domain simply by differencing the pulse positions or having them precomputed in a look-up table (as there are a limited number of pulse positions defined by the codebook).

As those skilled in the art will appreciate, the resulting spectrograph obtained in this manner is not directly comparable to that derived from the FFT of the audio samples, due to the approximations that are made. However, the spectrograph carries adequate and similar information to the conventional spectrograph so that the same or similar pattern matching techniques can be used for the audio recognition. For best results, the pattern information stored in the database 211 is preferably generated from spectrographs obtained in a similar manner (i.e. from the AMR codec output, rather than using those generated directly from the audio samples).

### Modifications and Further Alternatives

A number of embodiments have been described above illustrating the way in which an audio codec in a cellular telephone may be used to reduce the subsequent processing performed by other parts of the telephone in order to recover hidden information or to identify an input audio segment. As those skilled in the art will appreciate various modifications and improvements can be made to the above embodiments and some of these modifications will now be described.

In the above audio recognition embodiment, all of the pattern database 211 was stored within the cellular telephone 21. In an alternative embodiment, the pattern matching section 209 may be arranged to generate a hash function from the characteristic features of the spectrograph generated for the audio and the result of this hash function may then be transmitted to a remote server which downloads the appropriate pattern information to be matched with the audio's spectrograph. In this way the amount of data that has to be stored within the pattern database 211 on the cellular telephone 21 can be kept to a minimum whilst introducing only a relatively small delay in the processing to retrieve selected patterns from the remote database.

In the above audio recognition embodiment, the line spectral frequencies were converted back to LPC coefficients, which were then transformed into the frequency domain using an FFT. In an alternative embodiment, the spectrum for the LPC data may be determined directly from the line spectral frequencies or from the poles derived from them. This would reduce further the processing that is required to perform the audio recognition.

In the earlier embodiments described above, data was hidden within the audio and used to synchronise the operation of the telephone to a television programme being viewed by the user. In the last embodiment just described, there is no hidden data within the audio and, instead, characteristic features of the audio are indentified and used to recognise the audio. As those skilled in the art will appreciate, similar audio recognition techniques can be used in the synchronisation embodiments. For example, the software application running on the telephone may synchronise itself to the television programme by identifying predetermined portions within the audio soundtrack. This type of synchronising can also be used to control the outputting of subtitles for the television programme.

In the earlier embodiments described above, the hidden data was recovered by determining autocorrelation values of the LPC coefficients or the impulse response of the synthesis filter. This correlation processing is not essential as the hidden data can be found by monitoring the coefficients or impulse response directly. However, the autocorrelation processing is preferred as it makes it easier to identify the echoes.

In the refinements described above, various high pass filtering techniques were used to filter out low frequency components associated with the audio and the room acoustics. In a preferred embodiment, where such high pass filtering is performed in the cellular telephone, the echo signal is preferably only added (during the hiding process) to the audio in the high frequency part of the AMR band. For example above 1 kHz and preferably above 2 kHz only. This can be achieved, for example, by filtering the audio signal to remove the lower frequency AMR band components and then adding the filtered output to the original audio with the required time delay. This is preferred as it reduces the energy in the echo signal that will be filtered out (and therefore lost) by the high pass filtering performed in the cellular telephone.

In the above embodiments, it has been assumed that the audio codec used by the cellular telephone is the AMR codec. However, as those skilled in the art will appreciate the principles and concepts described above are also applicable to other types of audio codec and especially those that rely on a linear prediction analysis of the input audio.

In the above embodiments, the various processing of the compressed audio data output from the audio codec has been performed by software running on the cellular telephone. As those skilled in the art will appreciate, some or all of this processing may be formed by dedicated hardware circuits, although software is preferred due to its ability to be added to the cellular telephone after manufacture and its ability to be updated once loaded. The software for causing the cellular telephone to operate in the above manner may be provided as a signal or on a carrier such as compact disc or other carrier medium.

In the above embodiments, the processing has been performed within a cellular telephone. However, as those skilled in the art will appreciate, the benefits will apply to any communication device which has an inbuilt audio codec.

In the early embodiments described above, data was hidden within the audio and used to synchronise the operation of the cellular telephone with the television show being watched by the user. As those skilled in the art will appreciate, and as described in WO02/45273, there are various other uses for the hidden data. For example, the hidden data may identify a URL for a remote location or may identify a code to be sent to a pre-stored URL for interpretation. Such hidden data can provide the user with additional information about, for example, the television programme and/or to provide special offers or other targeted advertising for the user.

In the above embodiment, the television programme was transmitted to the user via an RF communication link 13. As those skilled in the art will appreciate, the television programme may be distributed to the user via any appropriate distribution technology, such as by cable TV, the Internet, Satellite TV etc. It may also be obtained from a storage medium such as a DVD and read out by an appropriate DVD player.

In the above embodiments, the cellular telephone picked up the audio of a television programme. As those skilled in the art will appreciate, the above techniques can also be used where the audio is obtained from a radio or other loudspeaker system.

In the above embodiments, it was assumed that the data was hidden within the audio at the television studio end of the television system. In an alternative embodiment, the data may be hidden within the audio at the user's end of the television system, for example, by a set top box. The set top box may be adapted to hide the appropriate data into the audio prior to outputting the television programme to the user.

In the above embodiments, the software application processed the compressed audio data received from the AMR codec within the cellular telephone 21. In an alternative embodiment, the software application may perform similar processing on compressed audio data received over the telephone network and provided to the processor 63 by the RF processing unit 57.

In the above embodiments, it is assumed that the output of the audio codec does not include the LPC coefficients themselves, but other parameters derived from them, such as the line spectral frequencies or the filter poles of the LPC synthesis filter. As those skilled in the art will appreciate, if the audio codec employed in the cellular telephone 21 is such that the LPC coefficients derived by it are available to the processor 63 then the initial processing performed by the application software to recover the LPC coefficients is not necessary and the software applications can work directly on the LPC coefficients output by the audio codec. This will reduce the required processing further.

As those skilled in the art will appreciate, the precise values of the bit rates, sampling rates etc described in the above embodiments are not essential features of the invention and can be varied without departing from the invention.

1. A method of recovering hidden data from an input audio signal or of identifying an input audio signal using a telecommunications device having an audio coder for compressing an input audio signal for transmission to a telecommunications network, the method being performed by the telecommunications device and being characterised by passing the input audio signal through the audio codec to generate compressed audio data and processing the compressed audio data to recover the hidden data or to identify the input audio signal.

2. A method according to claim 1, wherein the audio coder performs a linear prediction, LP, analysis on the input audio to generate LP data representative of the input audio and wherein the processing step processes the LP data to recover the hidden data or to identify the input audio signal.

3. A method according to claim 2, wherein the audio coder compresses the LP data to generate said compressed LP data and wherein said processing step includes step of regenerating the LP data from the compressed audio data.

4. A method according to claim 2, wherein the LP data comprises LP filter data and the processing step recovers the hidden data or identifies the audio signal using the LP filter data.

5. A method according to claim 4, wherein the processing step includes the step of generating an impulse response of a synthesis filter or the step of performing a reverse Levinson-Durbin algorithm on the LP filter data.

6. A method according to claim 2, wherein the LP data comprises LP excitation data and the processing step recovers the hidden data or identifies the audio signal using the LP excitation data.

7. A method according to claim 2, wherein the LP data comprises LP filter data and LP excitation data and wherein the processing step processes a subset of the compressed audio data corresponding to one of said LP filter data and said LP excitation data to recover the hidden data.

8. A method according to claim 1, wherein the audio signal includes hidden data defined by one or more echoes of the audio signal and wherein the processing step processes the compressed audio to identify the presence of echoes within the audio signal to recover the hidden data.

9. A method according to claim 1, wherein each data symbol of the hidden data is represented by a combination of echoes or a sequence of echoes within the audio signal and wherein the processing step includes the step of identifying the combinations of echoes to recover the hidden data or the step of tracking a sequence of echoes in the audio to recover the hidden data.

10. A method according to claim 8, wherein the audio coder has a predefined operating frequency band and wherein the echoes are hidden within the audio within a predetermined portion of the operating band, preferably an upper portion of the frequency band, and wherein the processing step includes a filtering step to filter out frequencies outside said predetermined portion.

11. A method according to claim 1, wherein the processing step determines one or more autocorrelation values for each of a sequence of time frames of the audio signal and recovers the hidden data using the determined autocorrelation values.

12. A method according to claim 11, wherein the processing step performs a high pass filtering of the determined autocorrelation values to remove slowly varying correlations.

13. A method according to claim 1, wherein the processing step recovers the hidden data or identifies the audio without regenerating digitised audio samples from the compressed audio data.

14. A telecommunications device comprising:
a microphone that receives acoustic signals and that converts the received acoustic signals into corresponding electrical audio signals;
an analog to digital converter that samples the electrical audio signals to produce digital audio samples;
an audio coder that compresses the digital audio samples to generate compressed audio data for transmission to a telecommunications network; and
a data processor, coupled to said audio coder, that processes the compressed audio data to recover hidden data conveyed within the received acoustic signal or to identify the received acoustic signal.

15. A device according to claim 14, wherein the audio coder is operable to perform a linear prediction, LP, analysis on the input audio to generate LP data representative of the input audio and wherein the data processor is operable to process the LP data to recover the hidden data or to identify the input audio signal.

16. A device according to claim 15, wherein the audio coder is operable to compress the LP data to generate said compressed LP data and wherein said data processor is operable to regenerate the LP data from the compressed audio data.

17. A device according to claim 15, wherein the LP data comprises LP filter data and the data processor is operable to recover the hidden data or to identify the audio signal using the LP filter data.

18. A device according to claim 17, wherein the data processor is operable to generate an impulse response of a synthesis filter or to perform a reverse Levinson-Durbin algorithm on the LP filter data to recover the hidden data.

19. A device according to claim 15, wherein the LP data comprises LP excitation data and the data processor is operable to recover the hidden data or to identify the audio signal using the LP excitation data.

20. A device according to claim 15, wherein the LP data comprises LP filter data and LP excitation data and wherein the data processor is operable to process a subset of the compressed audio data corresponding to one of said LP filter data and said LP excitation data to recover the hidden data.

21. A device according to claim 14, wherein the audio signal includes hidden data defined by one or more echoes of the audio signal and wherein the data processor is operable to process the compressed audio data to identify the presence of echoes within the audio signal to recover the hidden data.

22. A device according to claim 14, wherein each data symbol of the hidden data is represented by a combination of echoes or a sequence of echoes within the audio signal and wherein the data processor is operable to identify the combinations of echoes to recover the hidden data or to track a sequence of echoes in the audio to recover the hidden data.

23. A device according to claim 21, wherein the audio coder has a predefined operating frequency band and wherein the echoes are hidden within the audio within a predetermined portion of the operating band, preferably an upper portion of the frequency band, and wherein the data processor is operable to filter out frequencies outside said predetermined portion.

24. A device according to claim 14, wherein the data processor is operable to determine one or more autocorrelation values for each of a sequence of time frames and is operable to recover the hidden data using the determined autocorrelation values.

25. A device according to claim 24, wherein the data processor is operable to perform a high pass filtering of the determined autocorrelation values to remove slowly varying correlations.

26. A device according to claim 14, wherein the data processor is operable to perform inter and/or intra frame high pass filtering when recovering the hidden data.

27. A device according to claim 14, wherein the data processor is operable to recover the hidden data or to identify the audio without regenerating digitised audio samples from the compressed audio data.

28. A data hiding apparatus comprising:
audio coding means for receiving and compressing digital audio samples representative of an audio signal to generate compressed audio data;
means for receiving data to be hidden within the audio signal and for varying the compressed audio data in dependence upon the received data, to generate modified compressed audio data; and
means for generating audio samples using the modified compressed audio data, the audio samples representing the original audio signal and conveying the hidden data.

29. A method of hiding data in an audio signal, the method comprising the steps of adding one or more echoes to the audio in dependence upon the data to be hidden in the audio signal and characterised by high pass filtering the echo before combining it with the audio signal.

30. (canceled)

31. (canceled)

32. A computer implementable instructions product comprising computer implementable instructions for causing a programmable processor to perform the processing steps of claim 1.
